(19) United States
(12) Patent Application Publication
(10) Pub. No.: US 2005/0219126 A1
(43) Pub. Date: Oct. 6, 2005

(54) MULTI-BEAM ANTENNA

(75) Inventors: Gabriel M. Rebeiz, Ann Arbor, MI (US); James P. Ebling, Ann Arbor, MI (US); Bernhard Schoenlinner, Trostberg (DE)

Correspondence Address: RAGGIO & DINNIN, P.C., 2701 CAMBRIDGE COURT, STE. 410, AUBURN HILLS, MI, 48326, US

(73) Assignee: AUTOMOTIVE SYSTEMS LABORATORY, INC., Farmington Hills, MI (US)

(21) Appl. No.: 10/907,305

(22) Filed: Mar. 28, 2005

Related U.S. Application Data
(60) Provisional application No. 60/521,284, filed on Mar. 26, 2004.
(60) Provisional application No. 60/522,077, filed on Aug. 11, 2004.

(51) Int. Cl. H01Q 1/38

(52) U.S. Cl. 343/700 MS

(57) ABSTRACT

A plurality of antenna elements on a dielectric substrate are adapted to launch or receive electromagnetic waves in or from a direction substantially away from either a convex or concave edge of the dielectric substrate, wherein at least two of the antenna elements operate in different directions. Slotlines of tapered-slot endfire antennas in a first conductive layer of a first side of the dielectric substrate are coupled to microstrip lines of a second conductive layer on the second side of the dielectric substrate. A bi-conical reflector, conformal cylindrical dielectric lens, or planar lens improves the H-plane radiation pattern. Dipole or Yagi-Uda antenna elements on the conductive layer of the dielectric substrate can be used in cooperation with associated reflective elements, either alone or in combination with a corner-reflector of conductive plates attached to the conductive layers proximate to the endfire antenna elements.

### CROSS-REFERENCE TO RELATED APPLICATIONS

The instant application claims the benefit of prior U.S. Provisional Application Ser. No. 60/521,284 filed on Mar. 26, 2004, and of prior U.S. Provisional Application Ser. No. 60/522,077 filed on Aug. 11, 2004, both of which are incorporated herein by reference. The subject matter of the instant application is related in-part to U.S. application Ser. No. 10/604,716 filed on Aug. 12, 2003, which is incorporated herein by reference.

### BRIEF DESCRIPTION OF THE DRAWINGS

In the accompanying drawings:

FIG. 1 illustrates a top plan view of a first embodiment of a multi-beam antenna;

FIG. 2 illustrates a side cross-sectional view of the embodiment of FIG. 1;

FIG. 3 illustrates a top plan view of an embodiment of a multi-beam antenna;

FIGS. 4a-4f illustrate various embodiments of tapered slot antenna elements;

FIG. 5 illustrates a tapered slot antenna element and an associated coordinate system;

FIG. 6 illustrates a junction where a microstrip line is adapted to couple to a slotline feeding a tapered slot antenna;

FIG. 7 illustrates a bottom view of the embodiment of the multi-beam antenna illustrated in FIG. 3 interfaced to an associated feed network;

FIG. 8 illustrates a bottom view of the embodiment of the multi-beam antenna illustrated in FIG. 3 with associated receiver circuitry;

FIG. 9 illustrates a detailed view of the receiver circuitry for the embodiment illustrated in FIG. 8;

FIG. 10 illustrates an antenna gain pattern for the multi-beam antenna illustrated in FIGS. 3 and 8;

FIG. 11a illustrates an isometric view of an embodiment of a multi-beam antenna incorporating a bi-conical reflector;

FIG. 11b illustrates a cross-sectional view of the embodiment of a multi-beam antenna illustrated in FIG. 11a incorporating a bi-conical reflector;

FIG. 12a illustrates a top plan view of an embodiment of a multi-beam antenna incorporating a conformal cylindrical dielectric lens;

FIG. 12b illustrates a cross-sectional view of the embodiment of a multi-beam antenna illustrated in FIG. 12a incorporating a circular cylindrical lens;

FIG. 13a illustrates a top plan view of an embodiment of a multi-beam antenna incorporating a planar lens;

FIG. 13b illustrates a cross-sectional view of the embodiment of a multi-beam antenna illustrated in FIG. 13a incorporating a planar lens;

FIG. 14 illustrates a first side of a planar discrete lens array;

FIG. 15 illustrates a block diagram of a discrete lens array;

FIG. 16 illustrates a plot of delay as a function of transverse location on the planar discrete array of FIG. 15;

FIG. 17 illustrates a fragmentary cross sectional isometric view of an embodiment of a discrete lens antenna element;

FIG. 18 illustrates an isometric view of the discrete lens antenna element illustrated in FIG. 17, isolated from associated dielectric substrates;

FIG. 19a illustrates a top plan view of an embodiment of a multi-beam antenna incorporating a dipole antenna adapted to cooperate with an associated corner reflector;

FIG. 19b illustrates a cross-sectional view of the embodiment of a multi-beam antenna illustrated in FIG. 19a incorporating a dipole antenna and an associated corner reflector;

FIGS. 20a and 20b illustrate a Yagi-Uda antenna element with a first embodiment of an associated feed circuit;

FIG. 21 illustrates the operation of the Yagi-Uda antenna element illustrated in FIGS. 20a and 20b in cooperation with a dielectric lens having a circular profile;

FIG. 22 illustrates a Yagi-Uda antenna element with a second embodiment of an associated feed circuit;

FIG. 23 illustrates an embodiment of a mulit-beam antenna incorporating a plurality of Yagi-Uda antenna elements on a concave edge of a dielectric substrate;

FIG. 24 illustrates an embodiment of a mulit-beam antenna incorporating a plurality of Yagi-Uda antenna elements on a concave edge of a dielectric substrate, in cooperation with an at least partially spherical dielectric lens;

FIGS. 25a and 25b illustrate an embodiment of a mulit-beam antenna incorporating a plurality of endfire antenna elements on a concave edge of a dielectric substrate, in cooperation with an associated bi-conical reflector;

FIG. 26 illustrates a circular multi-beam antenna;

FIGS. 27a and 27b illustrate a first non-planar embodiment of a multi-beam antenna; and

FIGS. 28a and 28b illustrate a second non-planar embodiment of a multi-beam antenna.

### DETAILED DESCRIPTION OF EMBODIMENT(S)

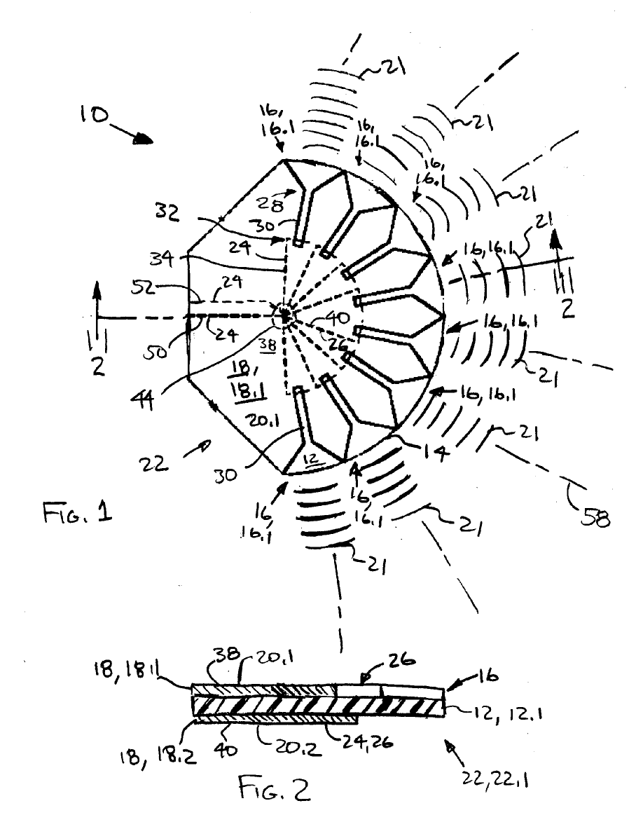

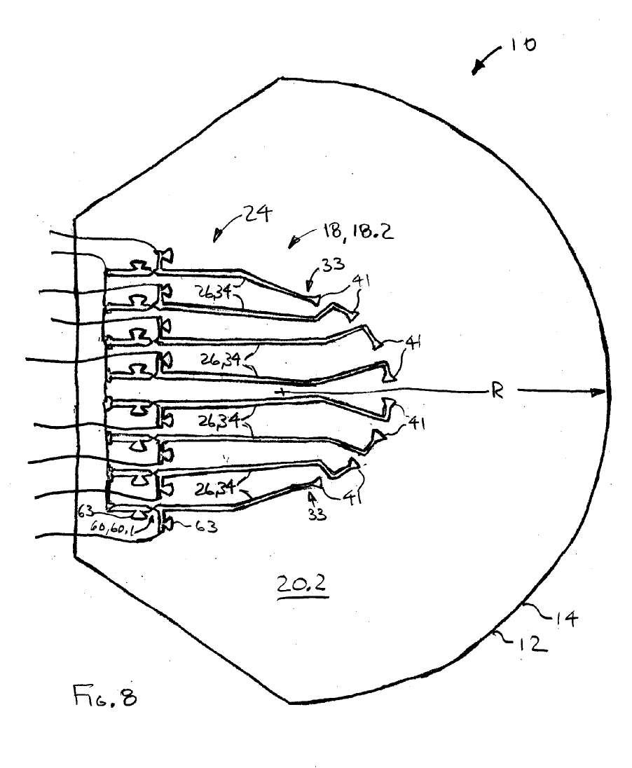

Referring to FIGS. 1-3, 7 and 8, in accordance with a first aspect, a multi-beam antenna 10 comprises a dielectric substrate 12 having a convex profile 14—e.g. circular, semi-circular, quasi-circular, elliptical, or some other profile shape as may be required—with a plurality of endfire antenna elements 16 etched into a first conductive layer 18.1 on the first side 20.1 of the dielectric substrate 12. The plurality of endfire antenna elements 16 are adapted to radiate a corresponding plurality of beams of electromagnetic energy 21 radially outwards from the convex profile 14 of the dielectric substrate 12, or to receive a corresponding plurality of beams of electromagnetic energy 21 propagating towards the convex profile 14 of the dielectric substrate 12. For example, the endfire antenna elements 16 are illustrated as abutting the convex profile 14.

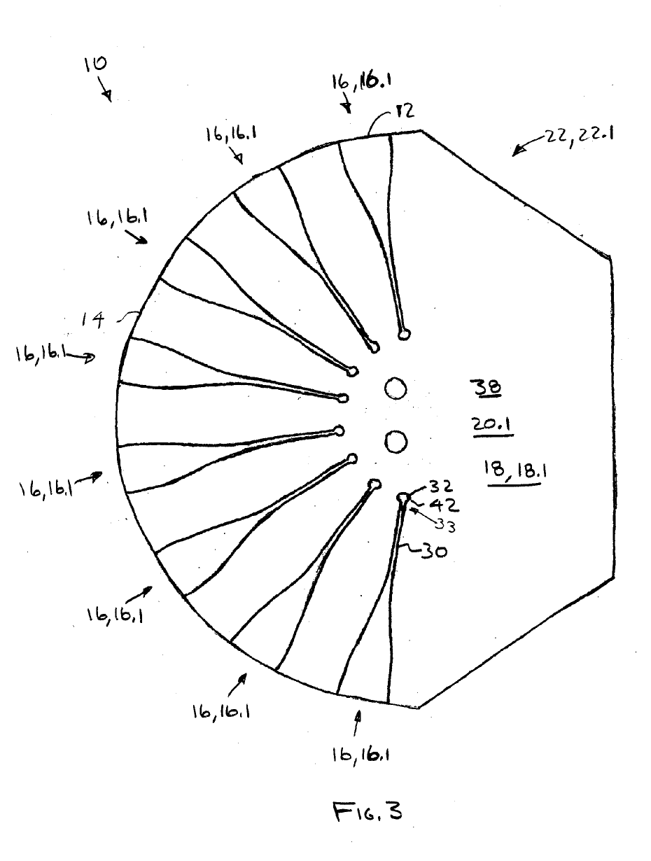

The dielectric substrate 12 is, for example, a material with relatively low loss at an operating frequency, for example, DUROID®, a TEFLON® containing material, a ceramic material, or a composite material such as an epoxy/fiberglass composite. Moreover, in one embodiment, the dielectric substrate 12 comprises a dielectric 12.1 of a circuit board 22, for example, a printed or flexible circuit 22.1 comprising at least one conductive layer 18 adhered to the dielectric substrate 12, from which the endfire antenna elements 16 and other associated circuit traces 24 are formed, for example, by subtractive technology, for example, chemical or ion etching, or stamping; or additive techniques, for example, deposition, bonding or lamination. For example, the multi-beam antenna 10 illustrated in FIGS. 3, 7 and 8 was fabricated on an RT/DUROID® 5880 substrate with a copper layer of 17 micrometers thickness on either side with a fabrication process using a one-mask process with one lithography step.

An endfire antenna element 16 may, for example, comprise either a Yagi-Uda antenna, a coplanar horn antenna (also known as a tapered slot antenna), a Vivaldi antenna, a tapered dielectric rod, a slot antenna, a dipole antenna, or a helical antenna, each of which is capable of being formed on the dielectric substrate 12, for example, from a printed or flexible circuit 22.1, for example, by subtractive technology, for example, chemical or ion etching, or stamping; or additive techniques, for example, deposition, bonding or lamination. The endfire antenna element 16 could also comprise a monopole antenna, for example, a monopole antenna element oriented either in-plane or out-of-plane with respect to the dielectric substrate 12. Furthermore, the endfire antenna elements 16 may be used for transmitting, receiving or both.

For example, the embodiments illustrated in FIGS. 1 and 3 incorporate tapered-slot antennas 16.1 as the associated endfire antenna elements 16. The tapered-slot antenna 16.1 is a surface-wave traveling-wave antenna, which generally allows wider band operation in comparison with resonant structures, such as dipole or Yagi-Uda antennas. The directivity of a traveling-wave antenna depends mostly upon length and relatively little on its aperture. The aperture is typically larger than a half free space wavelength to provide for proper radiation and low reflection. For a very short tapered-slot antenna 16.1, the input impedance becomes mismatched with respect to that of an associated slotline feed and considerable reflections may occur. Longer antennas generally provide for increased directivity. Traveling-wave antennas generally are substantially less susceptible to mutual coupling than resonant antennas, which makes it possible to place them in close proximity to each other without substantially disturbing the radiation pattern of the associated multi-beam antenna 10.

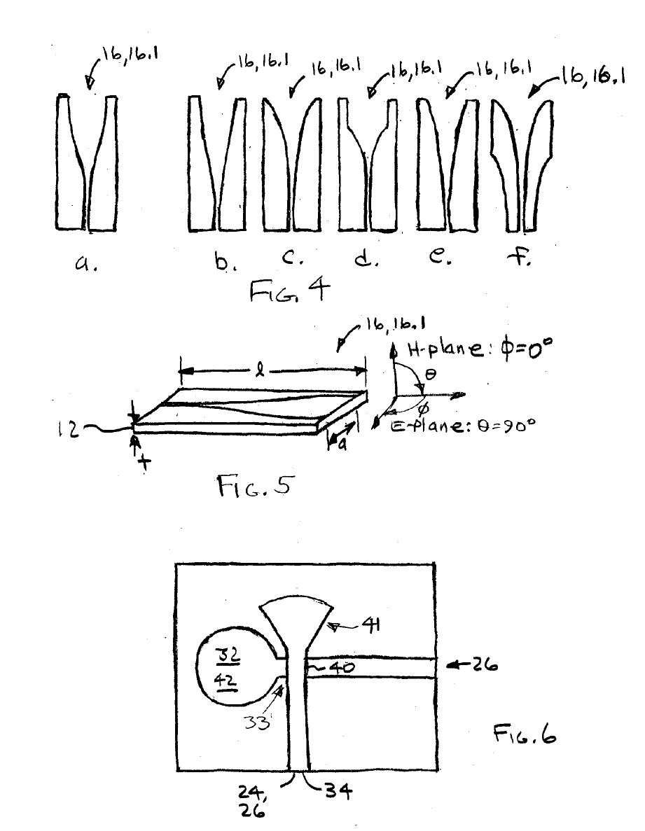

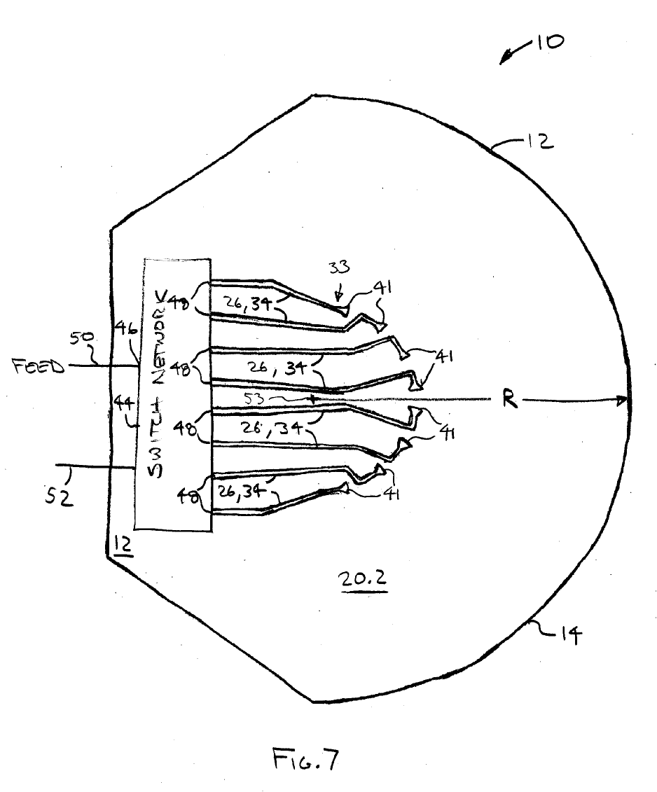

The tapered-slot antenna 16.1 comprises a slot in a conductive ground plane supported by a dielectric substrate 12. The width of the slot increases gradually in a certain fashion from the location of the feed to the location of interface with free space. As the width of the slot increases, the characteristic impedance increases as well, thus providing a smooth transition to the free space characteristic impedance of 120 times pi Ohms. Referring to FIGS. 4a-4f, a variety of tapered-slot antennas 16.1 are known, for example, a Fermi tapered slot antenna (FTSA) illustrated in FIGS. 3 and 4a; a linearly tapered slot antenna (LTSA) illustrated in FIGS. 1 and 4b; a Vivaldi exponentially tapered slot antenna (Vivaldi) illustrated in FIG. 4c; a constant width slot antenna (CWSA) illustrated in FIG. 4d; a broken linearly tapered slot antenna (BLTSA) illustrated in FIG. 4e; and a dual exponentially tapered slot antenna (DETSA) illustrated in FIG. 4f. Referring to FIG. 5, the tapered-slot antenna 16.1 exhibits an E-field polarization that is in the plane of the tapered-slot antenna 16.1.

These different types of tapered-slot antennas 16.1 exhibit corresponding different radiation patterns, also depending on the length and aperture of the slot and the supporting substrate. Generally, for the same substrate with the same length and aperture, the beamwidth is smallest for the CWSA, followed by the LTSA, and then the Vivaldi. The sidelobes are highest for the CWSA, followed by the LTSA, and then the Vivaldi. The Vivaldi has theoretically the largest bandwidth due to its exponential structure. The BLTSA exhibits a wider −3 dB beamwidth than the LTSA and the cross-polarization in the D-plane (diagonal plane) is about 2 dB lower compared to LTSA and CWSA. The DETSA has a smaller −3 dB beamwidth than the Vivaldi, but the sidelobe level is higher, although for higher frequency, the sidelobes can be suppressed. However, the DETSA gives an additional degree of freedom in design especially with regard to parasitic effects due to packaging. The FTSA exhibits very low and the most symmetrical sidelobe level in E and H-plane and the −3 dB beamwidth is larger than the BLTSA.

The multi-beam antenna 10 may further comprise at least one transmission line 26 on the dielectric substrate 12 operatively connected to a corresponding at least one feed port 28 of a corresponding at least one of the plurality of endfire antenna elements 16 for feeding a signal thereto or receiving a signal therefrom. For example, the at least one transmission line 26 may comprise either a stripline, a microstrip line, an inverted microstrip line, a slotline, an image line, an insulated image line, a tapped image line, a coplanar stripline, or a coplanar waveguide line formed on the dielectric substrate 12, for example, of a printed or flexible circuit 22.1, for example, by subtractive technology, for example, chemical or ion etching, or stamping; or additive techniques, for example, deposition, bonding or lamination.

Referring to FIGS. 1, 3 and 6, each of the tapered-slot endfire antenna elements 16.1 interface with an associated slotline 30 by which energy is coupled to or from the tapered-slot endfire antenna element 16.1. The slotlines 30 are terminated with at a terminus 32 on the first side 20.1 of the dielectric substrate 12, proximate to which the slotlines 30 is electromagnetically coupled at a coupling location 33 to a microstrip line 34 on the opposite or second side 20.2 of the dielectric substrate 12, wherein the first conductive layer 18.1 on the first side 20.1 of the dielectric substrate 12 constitutes an associated conductive ground layer 38 of the microstrip line 34, and the conductor 40 of the microstrip line 34 is formed from a second conductive layer 18.2 on the second side 20.2 of the dielectric substrate 12.

Referring to FIGS. 1, and 6-8, a transition between the microstrip line 34 and the slotline 30 is formed by etching the slotline 30 into the conductive ground layer 38 of the microstrip line 34 and is crossed by the conductor 40 of the microstrip line 34 oriented substantially perpendicular to the axis of the slotline 30, as is illustrated in detail in FIG. 6. A transition distance of about one wavelength provides matching the 50 Ohm impedance of the microstrip line 34 to the 100 Ohm impedance of the slotline 30. The coupling of the fields between the microstrip line 34 and slotline 30 occurs through an associated magnetic field, and is strongest when the intersection of the conductor 40 and slotline 30 occurs proximate to a short circuit of the microstrip line 34—where the current therein is a maximum—and an open circuit of the slotline 30. Because short circuits in a microstrip line 34 require via holes, it is easier to terminate the microstrip line 34 in an open circuit a quarter guided wavelength from the transition intersection, where quarter guided wavelength is that of the microstrip line 34. A quarter-wave radial stub 41 can provide for relatively wider bandwidth. An open circuit in the slotline 30 is created by truncating the conductive ground layer 38, which is generally impractical. Alternatively, and preferably, the slotline 30 is terminated with a short circuit and recessed from the intersection by a quarter guided wavelength of the slotline 30. The bandwidth can be increased by realizing the quarter-wave termination in a circular disc aperture 42, which is an approximation of an open circuit of a slotline 30. Generally, the open-circuit behavior improves with increasing radius of the circular disc aperture 42. Theoretically, the circular disc aperture 42 behaves like a resonator. The circular disc aperture 42 is capacitive in nature, and behaves as an open circuit provided that the operating frequency is higher than the resonance frequency of the circular disc aperture 42 resonator.

The multi-beam antenna 10 may further comprise a switching network 44 having at least one first port 46 and a plurality of second ports 48, wherein the at least one first port 46 is operatively connected—for example, via at least one above described transmission line 26—to a corporate antenna feed port 50, and each second port 48 of the plurality of second ports 48 is connected—for example, via at least one transmission line 26—to a respective feed port 28 of a different endfire antenna element 16 of the plurality of endfire antenna elements 16. The switching network 44 further comprises at least one control port 52 for controlling which second ports 48 are connected to the at least one first port 46 at a given time. The switching network 44 may, for example, comprise either a plurality of micro-mechanical switches, PIN diode switches, transistor switches, or a combination thereof, and may, for example, be operatively connected to the dielectric substrate 12, for example, by surface mount to an associated conductive layer 18 of a printed or flexible circuit 22.1, inboard of the endfire antenna elements 16. For example, the switching network 44 may be located proximate to the center 53 of the radius R of curvature of the dielectric substrate 12 so as to be proximate to the associated coupling locations 33 of the associated microstrip lines 34. The switching network 48, if used, need not be collocated on a common dielectric substrate 16, but can be separately located, as, for example, may be useful for relatively lower frequency applications, for example, 1-20 GHz.

In operation, a feed signal 54 applied to the corporate antenna feed port 50 is either blocked—for example, by an open circuit, by reflection or by absorption,—or switched to the associated feed port 28 of one or more endfire antenna elements 16, via one or more associated transmission lines 44, by the switching network 44, responsive to a control signal 60 applied to the control port 52. It should be understood that the feed signal 54 may either comprise a single signal common to each endfire antenna element 16, or a plurality of signals associated with different endfire antenna elements 16. Each endfire antenna element 16 to which the feed signal 54 is applied launches an associated electromagnetic wave into space. The associated beams of electromagnetic energy 21 launched by different endfire antenna elements 16 propagate in different associated directions 58. The various beams of electromagnetic energy 21 may be generated individually at different times so as to provide for a scanned beam of electromagnetic energy 21. Alternatively, two or more beams of electromagnetic energy 21 may be generated simultaneously. Moreover, different endfire antenna elements 16 may be driven by different frequencies that, for example, are either directly switched to the respective endfire antenna elements 16, or switched via an associated switching network 44 having a plurality of first ports 46, at least some of which are each connected to different feed signals 54.

Alternatively, the multi-beam antenna 10 may be adapted so that the respective signals are associated with the respective endfire antenna elements 16 in a one-to-one relationship, thereby precluding the need for an associated switching network 44. For example, each endfire antenna element 16 can be operatively connected to an associated signal through an associated processing element. As one example, with the multi-beam antenna 10 configured as an imaging array, the respective endfire antenna elements 16 are used to receive electromagnetic energy, and the corresponding processing elements comprise detectors. As another example, with the multi-beam antenna 10 configured as a communication antenna, the respective endfire antenna elements 16 are used to both transmit and receive electromagnetic energy, and the respective processing elements comprise transmit/receive modules or transceivers.

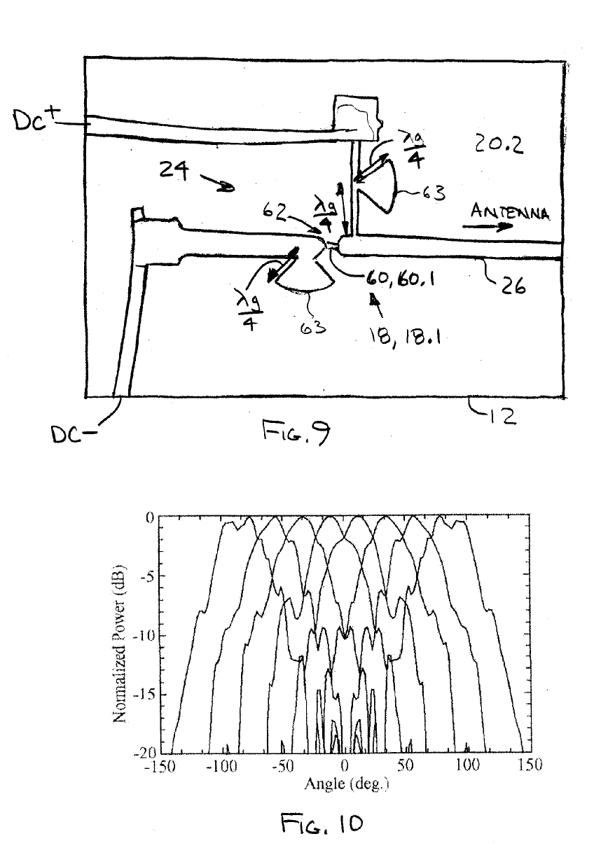

For example, referring to FIGS. 8 and 9, a multi-beam antenna 10 is adapted with a plurality of detectors 60 for detecting signals received by associated endfire antenna elements 16 of the multi-beam antenna 10, for example, to provide for making associated radiation pattern measurements. Each detector 60 comprises a planar silicon Schottky diode 60.1 mounted with an electrically conductive epoxy across a gap 62 in the microstrip line 34. For higher sensitivity, the diode 60.1 is DC-biased. Two quarter wavelength-stub filters 63 provide for maximizing the current at the location of the diode 60.1 detector 60 while preventing leakage into the DC-path. FIG. 10 illustrates an E-plane radiation pattern for the multi-beam antenna 10 illustrated in FIGS. 3 and 8, configured as a receiving antenna.

The tapered-slot endfire antenna elements 16.1 provide for relatively narrow individual E-plane beam widths, but inherently exhibit relatively wider H-plane beam widths, of the associated beams of electromagnetic energy 21.

Referring to FIGS. 11a and 11b, in accordance with a second aspect of a multi-beam antenna 10.1, the H-plane beam width may be reduced, and the directivity of the multi-beam antenna 10 may be increased, by sandwiching the above-described multi-beam antenna 10 within a bi-conical reflector 64, so as to provide for a horn-like antenna in the H-plane. In one embodiment, the opening angle between the opposing faces 65 of the bi-conic reflector is about 50 degrees and the lateral dimensions coincide with that of the dielectric substrate 12. The measured radiation patterns in E-plane of this embodiment exhibited a −3 dB beamwidth of 26 degrees and the cross-over of adjacent beams occurs at the −2.5 dB level. The sidelobe level was about −6 dB, and compared to the array without a reflector, the depth of the nulls between main beam and sidelobes was substantially increased. In the H-plane, the −3 and −10 dB beamwidths were 35 degrees and 68 degrees respectively, respectively, and the sidelobe level was below −20 dB. The presence of the bi-conical reflector 64 increased the measured gain by 10 percent. Although the improvement in gain is relatively small, e.g. about 10 percent, the bi-conical reflector 64 is beneficial to the H-plane radiation pattern.

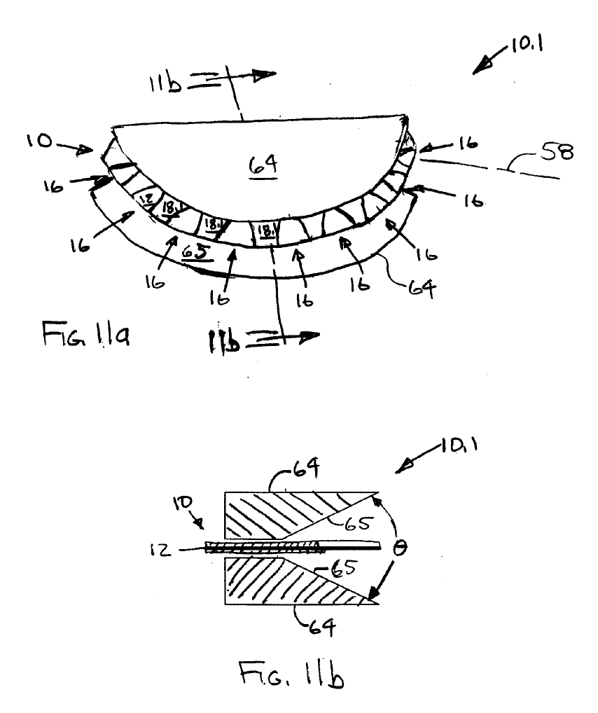

Referring to FIGS. 12a and 12b, in accordance with a third aspect of a multi-beam antenna 10.2, the H-plane beam width may be reduced, and the directivity of the multi-beam antenna 10 may be increased, by using a conformal cylindrical dielectric lens 66 which is bent along its cylindrical axis so as to conform to the convex profile 14 of the dielectric substrate 12, so as to provide for focusing in the H-plane without substantially affecting the E-plane radiation pattern. For example, the conformal cylindrical dielectric lens 66 could be constructed from either Rexolite™, Teflon™, polyethylene, or polystyrene; or a plurality of different materials having different refractive indices. Alternatively, the conformal cylindrical dielectric lens 66 could have a piano-cylindrical cross-section, rather than the circular cross-section as illustrated in FIG. 12b. In accordance with another embodiment, the conformal cylindrical dielectric lens 66 may be adapted to also act as a radome so as to provide for protecting the multi-beam antenna 10.2 from the adverse environmental elements (e.g. rain or snow) and factors, or contamination (e.g. dirt).

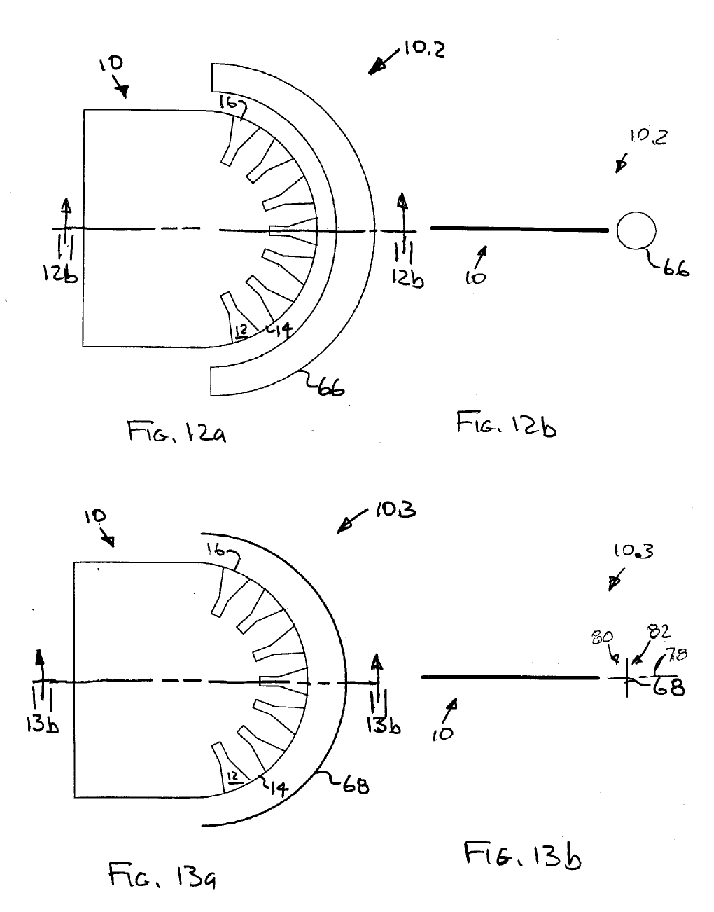

Referring to FIGS. 13a and 13b, in accordance with a fourth aspect of a multi-beam antenna 10.3, the H-plane beam width may be reduced, and the directivity of the multi-beam antenna 10 may be increased, by using a planar lens 68, the planar surface of which is oriented normal to the dielectric substrate 12 and—in a direction normal to the surface of the planar surface—is adapted to conform to the convex profile 14 of the dielectric substrate 12.

Referring to FIGS. 14-18, the planar lens 68 would comprise a plurality of first patch antennas 70.1 on one side of an associated dielectric substrate 72 of the planar lens 68 that are connected via associated delay elements 74, e.g. delay lines 76, to a corresponding plurality of second patch antennas 70.2 on the opposites side of the associated dielectric substrate 72 of planar lens 68, wherein the length of the delay lines 76 decreases with increasing distance—in a direction that is normal to the dielectric substrate 12—from the center 78 of the planar lens 68 which is substantially aligned with the dielectric substrate 12. The delay lines 76 can be constructed by forming meandering paths of appropriate length using printed circuit technology. One example of a cylindrical lens array is described by D. Popovic and Z. Popovic in “Mutlibeam Antennas with Polarization and Angle Diversity”, IEEE Transactions on Antennas and Propagation, Vol. 50, No. 5, May 2002, which is incorporated herein by reference.

In one embodiment of a planar lens 68, the patch antennas 70.1, 70.2 comprise conductive surfaces on the dielectric substrate 72, and the delay element 76 coupling the patch antennas 70.1, 70.2 of the first 80 and second 82 sides of the planar lens 68 comprise delay lines 76, e.g. microstrip or stipline structures, that are located adjacent to the associated patch antennas 70.1, 70.2 on the underlying dielectric substrate 72. The first ends 84.1 of the delay lines 76 are connected to the corresponding patch antennas 70.1, 70.2, and the second ends 84.2 of the delay lines 76 are interconnected to one another with a conductive path, for example, with a conductive via 86 though the dielectric substrate 72. FIG. 14 illustrates the delay lines 76 arranged so as to provide for feeding the associated first 70.1 and second 70.2 sets of patch antennas at the same relative locations.

Referring to FIG. 15, each patch antenna 70.1 on the first side 80 of the planar lens 68 is operatively coupled via a delay element 76 to a corresponding patch antenna 70.2 on the second side 82 of the planar lens 68, wherein the patch antenna 70.1 on the first side 80 of the planar lens 68 is substantially aligned with the corresponding patch antenna 70.2 on the second side 82 of the planar lens 68.

In operation, electromagnetic energy that is radiated upon one of the patch antennas 70.1, 70.2, e.g. a first patch antenna 70.1 on the first side 80 of the planar lens 68, is received thereby, and a signal responsive thereto is coupled via—and delayed by—the delay line 76 to the corresponding patch antenna 70.2, 70.1, e.g. the second patch antenna 70.2, wherein the amount of delay by the delay line 76 is dependent upon the location of the corresponding patch antennas 70.1, 70.2 on the respective first 80 and second 82 sides of the planar lens 68. The signal coupled to the second patch antenna 70.2 is then radiated thereby from the second side 82 of the planar lens 68. Accordingly, the planar lens 68 comprises a plurality of lens elements 88, wherein each lens element 88 comprises a first patch antenna element 70.1 operatively coupled to a corresponding second patch antenna element 70.2 via at least one delay line 76, wherein the first 70.1 and second 70.2 patch antenna elements are substantially opposed to one another on opposite sides of the planar lens 68.

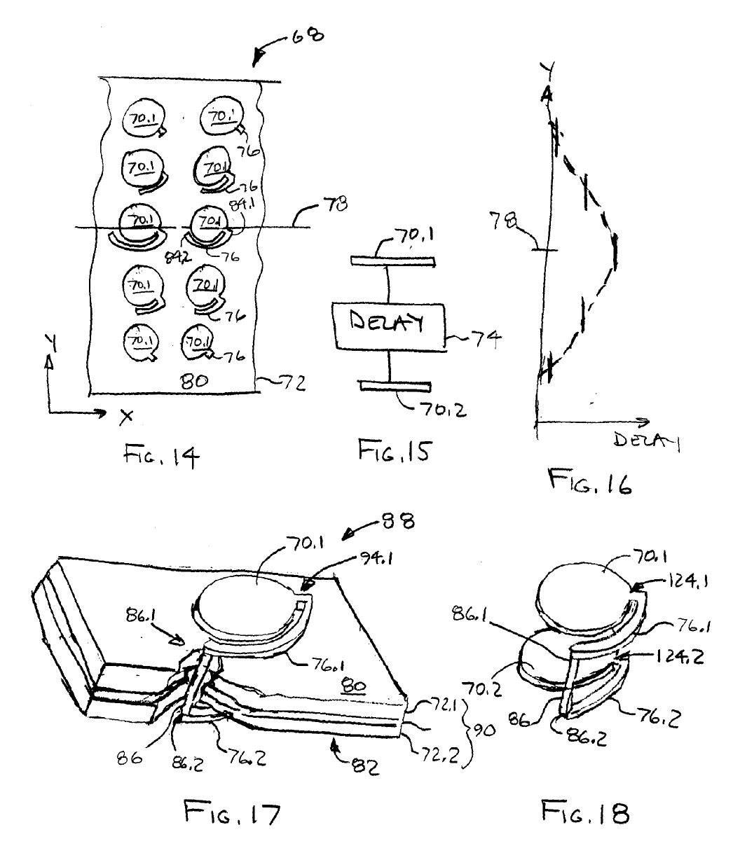

Referring to Referring to FIG. 16, the amount of delay caused by the associated delay lines 76 is made dependent upon the location of the associated patch antenna 102 in the planar lens 68, and, for example, is set by the length of the associated delay lines 76, as illustrated by the configuration illustrated in FIG. 14, so as to emulate the phase properties of a convex electromagnetic lens 12, e.g. a conformal cylindrical dielectric lens 66. The shape of the delay profile illustrated in FIG. 16 can be of various configurations, for example, 1) uniform for all radial directions, thereby emulating a spherical lens; 2) adapted to incorporate an azimuthal dependence, e.g. so as to emulate an elliptical lens; 3) adapted to provide for focusing in one direction only, e.g. in the elevation plane of the multi-beam antenna 10.6, e.g. so as to emulate a conformal cylindrical dielectric lens 66, or 4) adapted to direct the associated radiation pattern either above or below the plane of the associated multi-beam antenna 10.3, e.g. so as to mitigate against reflections from the ground, i.e. clutter.

Referring to FIGS. 17 and 18, a lens element 88 of the planar lens 68 illustrated in FIG. 14 comprises first 70.1 and second 70.2 patch antenna elements on the outer surfaces of a core assembly 90 comprising first 72.1 and second 72.2 dielectric substrates surrounding a conductive ground plane 92 sandwiched therebetween. A first delay line 76.1 on the first side 80 of the planar lens 68 extends circumferentially from a first location 94.1 on the periphery of the first patch antenna element 70.1 to a first end 86.1 of a conductive via 86 extending through the core assembly 90, and a second delay line 76.2 on the second side 82 of the planar lens 68 extends circumferentially from a second location 94.2 on the periphery of the second patch antenna element 70.2 to a second end 86.2 of the conductive via 86. Accordingly, the combination of the first 76.1 and second 76.2 delay lines interconnected by the conductive via 86 constitutes the associated delay line 76 of the lens element 88, and the amount of delay of the delay line 76 is generally responsive to the cumulative circumferential lengths of the associated first 76.1 and second 76.2 delay lines.

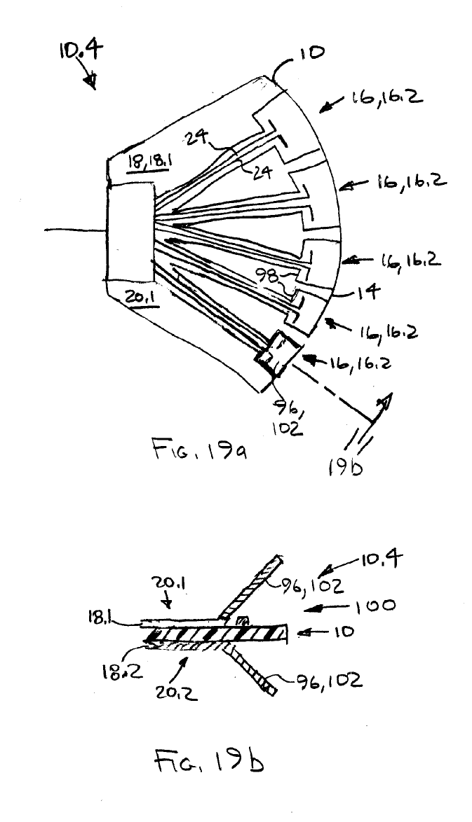

Referring to FIGS. 19a and 19b, in accordance with a fifth aspect of a multi-beam antenna 10.4, the dielectric substrate 12 with a plurality of associated endfire antenna elements 16 is combined with associated out-of-plane reflectors 96 above and below the dielectric substrate 12, in addition to any that are etched into the dielectric substrate 12 itself, so as to provide for improved the radiation patterns of the etched endfire antenna elements 16. For example, a dipole antenna 16.2 and an associated reflector portion 98 can be etched in at least one conductive layer 18 of the dielectric substrate 12. Alternatively, a Yagi-Uda element could used instead of the dipole antenna 16.2. The etched reflector portion 98 can also be extended away from the dielectric substrate 12 to form a planar corner reflector 100, e.g. by attaching relatively thin conductive plates 102 to the associated first 18.1 and second 18.2 conductive layers, e.g. using solder or conductive epoxy. For example, this would be similar to the metallic enclosures currently used to limit electromagnetic emissions and susceptibility on circuit boards. The reflectors 96 could also be made of solid pieces that span across all of the endfire antenna elements 16 on the dielectric substrate 12 with a common shape, such as for the bi-conical reflector 64 described hereinabove.

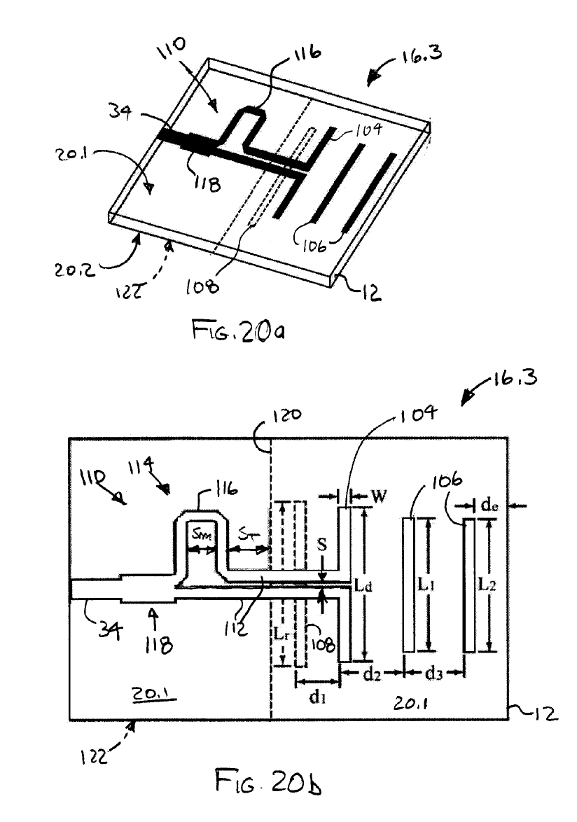

Referring to FIGS. 20a and 20b, a Yagi-Uda antenna 16.3 may be used as an endfire antenna element 16 of a multi-beam antenna 10, as described in “A 24-GHz High-Gain Yagi-Uda Antenna Array” by P. R. Grajek, B. Schoenlinner and G. M. Rebeiz in Transactions on Antennas and Propagation, May, 2004, which is incorporated herein by reference. For example, in one embodiment, a Yagi-Uda antenna 16.3 incorporates a dipole element 104, two forward director elements 106 on the first side 20.1 of the dielectric substrate 12—e.g. a 10 mil-thick DUROID® substrate—, and a reflector element 108 on the second side 20.2 of the dielectric substrate 12, so as to provide for greater beam directivity. For example, the initial dimensions of the antenna may be obtained from tables for maximum directivity in air using two directors, one reflector, and cylindrical-wire elements with a diameter d, and d/λ=0:0085, wherein the equivalent width of each element is obtained using w=2d, which maps a cylindrical dipole of diameter d to a flat strip with near-zero thickness, for example, resulting in an element width of 0.213 mm at 24 GHz. The dimensions are then scaled to compensate for the affects of the DUROID® substrate, e.g. so as to provide for the correct resonant frequency. In one embodiment, the feed gap S was limited to a width of 0.15 mm due to the resolution of the etching process.

In accordance with a first embodiment of an associated feed circuit 110, the Yagi-Uda antenna 16.3 is fed with a microstrip line 34 coupled to a coplanar stripline 112 coupled to the Yagi-Uda antenna 16.3. As described in “A new quasi-yagi antenna for planar active antenna arrays” by W. R. Deal, N. Kaneda, J. Sor, Y. Qian and T. Itoh in IEEE Trans. Microwave Theory Tech., Vol. 48, No. 6, pp. 910-918, June 2000, incorporated herein by reference, the transition between the microstrip line 34 and the coplanar stripline 112 is provided by splitting the primary microstrip line 34 into two separate coplanar stripline 112, one of which incorporates a balun 114 comprising a meanderline 116 of sufficient length to cause a 180 degree phase shift, so as to provide for exciting a quasi-TEM mode along the balanced coplanar striplines 112 connected to the dipole element 104. A quarter-wave transformer section 118 between the microstrip line 34 and the coplanar striplines 112 provides for matching the impedance of the coplanar stripline 112/Yagi-Uda antenna 16.3 to that of the microstrip line 34. The input impedance is affected by the gap spacing Sm of the measnerline 116 through mutual coupling in the balun 114, and by the proximity ST of the meanderline 116 to the edge 120 of the associated ground plane 122, wherein fringing effects can occur if the meanderline 116 of the is too close to the edge 120.

Referring to FIG. 21, the directivity of a Yagi-Uda antenna 16.3 can be substantially increased with an associated dielectric lens 124, for example, a dielectric lens 124 with a circular shape, e.g. a spherical, frusto-spherical or cylindrical lens, for example, that is fed from a focal plane with the phase center 126 of the Yagi-Uda antenna 16.3 at a distance d from the surface of the dielectric lens 124 of radius R, wherein, for example, in one embodiment, d/R=0.4.

Referring to FIG. 22, the Yagi-Uda antenna 16.3 is used as a receiving antenna in cooperation with a second embodiment of an associated feed circuit 128, wherein a detector 60 is operatively coupled across the coplanar striplines 112 from the associated dipole element 104, and λg/4 open-stubs 130 are operatively coupled to each coplanar stripline 112 at a distance of λg/4 from the detector 60, which provides for an an RF open circuit at the detector 60, and which provides for a detected signal at nodes 132 operatively coupled to the associated coplanar striplines 112 beyond the λg/4 open-stubs 130.

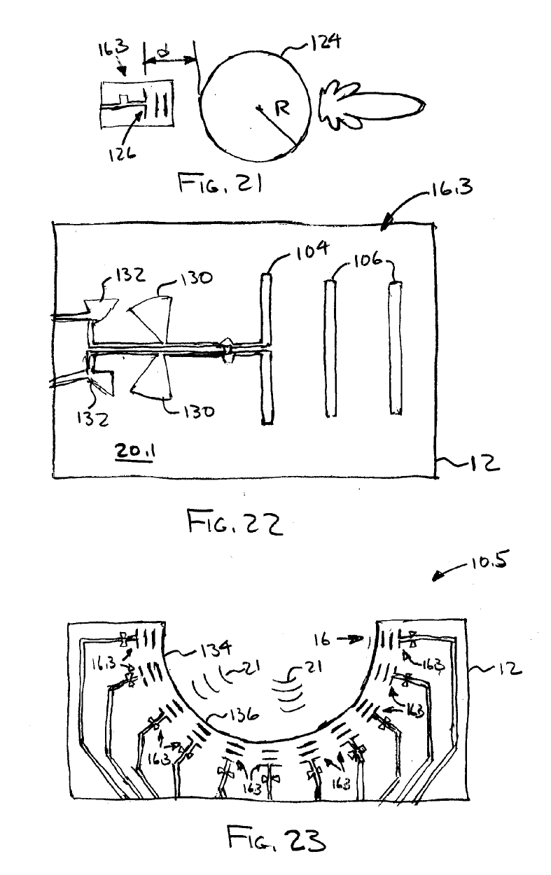

Referring to FIG. 23, in accordance with a sixth aspect, a multi-beam antenna 10.5 comprises a dielectric substrate 12 having a concave profile 134—e.g. circular, semi-circular, quasi-circular, elliptical, or some other profile shape as may be required—with a plurality of endfire antenna elements 16, for example, Yagi-Uda antennas 16.3 constructed in accordance with the embodiment illustrated in FIGS. 20a and 20b, with a second embodiment of the feed circuit 128 as illustrated in FIG. 22, so as to provide for receiving beams of electromagnetic energy 21 from a plurality of associated different directions corresponding to the different azimuthal directions of the associated endfire antenna elements 16 arranged along the edge 136 of the concave profile 134. The embodiment of the multi-beam antenna 10.5 illustrated in FIG. 23 comprises an 11-element array of Yagi-Uda antennas 16.3 that are evenly spaced with an angular separation of 18.7 degrees so as to provide for an associated −6 dB beam cross-over.

Referring to FIG. 24, in accordance with a seventh aspect of a multi-beam antenna 10.6, the multi-beam antenna 10.5 of the sixth aspect, for example, as illustrated in FIG. 23, is adapted to cooperate with an at least partially spherical dielectric lens 138, for example, a spherical TEFLON® lens, so as to provide for improved directivity, for example, as disclosed in U.S. Pat. No. 6,424,319, which is incorporated herein by reference.

Referring to FIGS. 25a and 25b, in accordance with an eighth aspect of a multi-beam antenna 10.7, the multi-beam antenna 10.5 of the sixth aspect, for example, as illustrated in FIG. 23, is adapted to cooperate with a concave bi-conical reflector 140, so as to provide for reducing the associated beam width in the H-plane, for example, as disclosed hereinabove in accordance with the embodiment illustrated in FIGS. 11a and 11b. Alternatively, all or part of the concave bi-conical reflector 140 may be replaced with out-of-plane reflectors 96, for example, as disclosed hereinabove in accordance with the embodiment illustrated in FIGS. 19a and 19b.

Referring to FIG. 26, in accordance with a second embodiment of the first aspect, the multi-beam antenna 10 comprises a dielectric substrate 12 with a convex profile 14, for example, a circular, quasi-circular or elliptical profile, wherein an associated plurality endfire antenna elements 16 etched into a first conductive layer 18.1 on the first side 20.1 of the dielectric substrate 12 are distributed around the edge 142 of the dielectric substrate 12 so as to provide for omni-directional operation. The plurality of endfire antenna elements 16 are adapted to radiate a corresponding plurality of beams of electromagnetic energy 21 radially outwards from the convex profile 14 of the dielectric substrate 12, or to receive a corresponding plurality of beams of electromagnetic energy 21 propagating towards the convex profile 14 of the dielectric substrate 12. For example, in one set of embodiments, the endfire antenna elements 16 are arranged so that the associated radiation patterns intersect one another at power levels ranging from −2 dB to −6 dB, depending upon the particular application. The number of endfire antenna elements 16 would depend upon the associated beamwidths and the associated extent of total angular coverall required, which can range from the minimum azimuthal extent covered by two adjacent endfire antenna elements 16 to 360 degrees for full omni-directional coverage.

One or more 1:N (for example, with N=4 to 16) switching networks 44 located proximate to the center of the dielectric substrate 12 provide for substantially uniform associated transmission lines 26 from the switching network 44 to the corresponding associated endfire antenna elements 16, thereby providing for substantially uniform associated losses. For example, the switching network 44 is fabricated using either a single integrated circuit or a plurality of integrated circuits, for example, a 1:2 switch followed by two 1:4 switches. For example, the switching network 44 may comprise either GaAs P-I-N diodes, Si P-I-N diodes, GaAs MESFET transistors, or RF MEMS switches, the latter of which may provide for higher isolation and lower insertion loss. The associated transmission line 26 may be adapted to beneficially reduce the electromagnetic coupling between different transmission lines 26, for example by using either vertical co-axial feed transmission lines 26, coplanar-waveguide transmission lines 26, suspended stripline transmission lines 26, or microstrip transmission lines 26. Otherwise, coupling between the associated transmission lines 26 can degrade the associated radiation patterns of the associated endfire antenna elements 16 so as to cause a resulting ripple in the associated main-lobes and increased associated sidelobe levels thereof. An associated radar unit can be located directly behind the switch matrix on either the same dielectric substrate 12 (or on a different substrate), so as to provide for reduced size and cost of an associated radar system. The resulting omni-directional radar system could be located on top of a vehicle so as to provide full azimuthal coverage with a single associated multi-beam antenna 10.

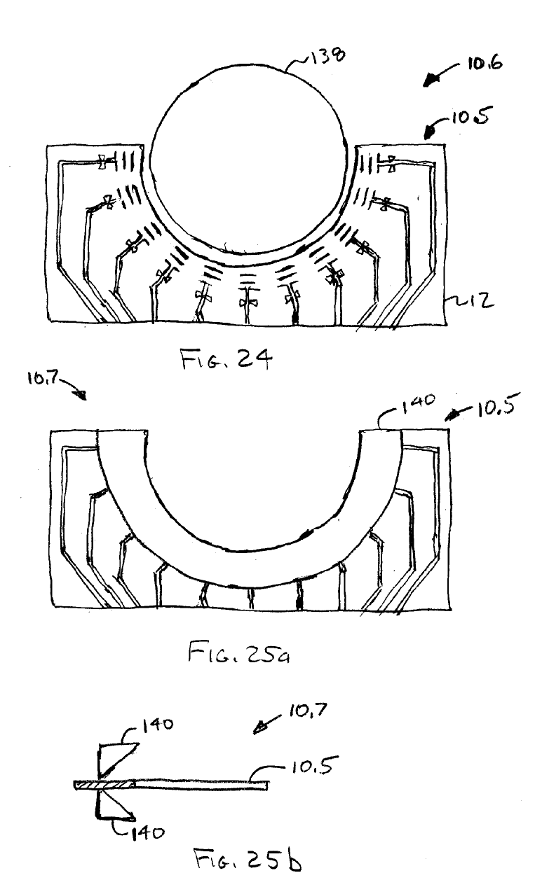

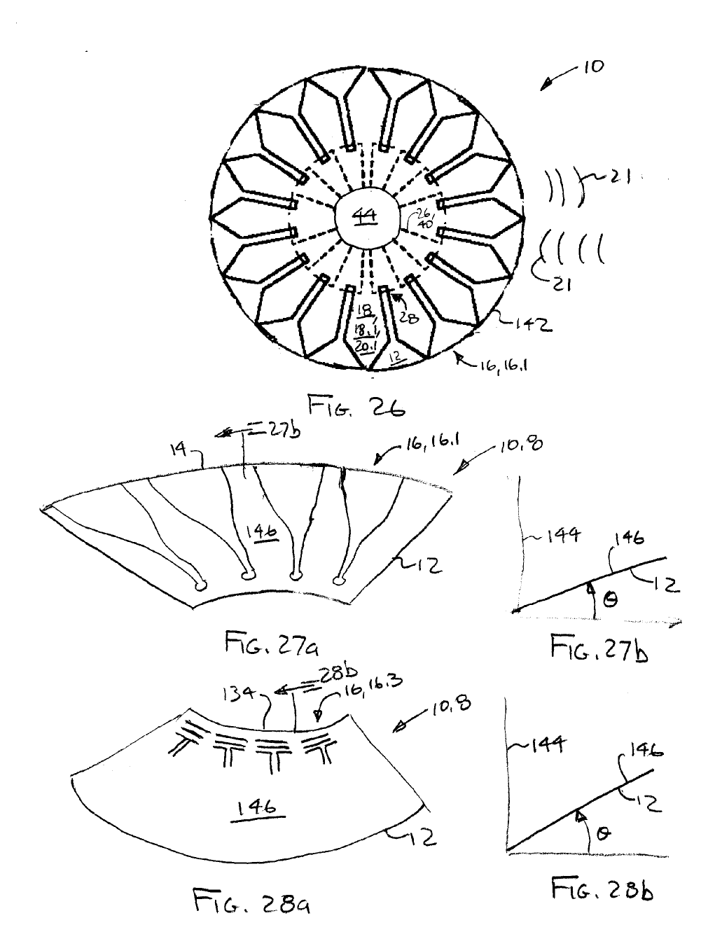

Referring to FIGS. 27a, 27b, 28a and 28b, in accordance with a ninth aspect of a multi-beam antenna 10.8, the dielectric substrate 12 can be angled in the vertical direction, either upward or downward in elevation, for example, so as to provide for eliminating or reducing associated ground reflections, also known as clutter. For example, referring to FIGS. 27a and 27b, the dielectric substrate 12 of a multi-beam antenna 10 with a convex profile 14 may be provided with a conical shape so that each of the associated endfire antenna elements 16 is oriented with an elevation angle towards the associated axis 144 of the conical surface 146, for example, so as to provide for orienting the associated directivity of the associated endfire antenna elements 16 upwards in elevation. Also for example, referring to FIGS. 28a and 28b, the dielectric substrate 12 of a multi-beam antenna 10 with a concave profile 134 may be provided with a conical shape so that each of the associated endfire antenna elements 16 is oriented with an elevation angle towards the associated axis 144 of the conical surface 146, for example, so as to provide for orienting the associated directivity of the associated endfire antenna elements 16 upwards in elevation. Accordingly, the dielectric substrate 12 of the multi-beam antenna 10 need not be planar.

The multi-beam antenna 10 provides for a relatively wide field-of-view, and is suitable for a variety of applications. For example, the multi-beam antenna 10 provides for a relatively inexpensive, relatively compact, relatively low-profile, and relatively wide field-of-view, electronically scanned antenna for automotive applications, including, but not limited to, automotive radar for forward, side, and rear impact protection, stop and go cruise control, parking aid, and blind spot monitoring. Furthermore, the multi-beam antenna 10 can be used for point-to-point communications systems and point-to-multi-point communication systems, over a wide range of frequencies for which the endfire antenna elements 16 may be designed to radiate, for example, 1 to 200 GHz. Moreover, the multi-beam antenna 10 may be configured for either mono-static or bi-static operation.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of any claims which are derivable from the description herein, and any and all equivalents thereof.

1. A multi-beam antenna, comprising: a dielectric substrate; and a plurality of antenna elements on said dielectric substrate, wherein at least two of said plurality of antenna elements each comprise an end-fire antenna adapted to launch, receive, or launch and receive electromagnetic waves in or from a direction substantially away from an edge of said dielectric substrate, and said direction for at least one said end-fire antenna is different from said direction for at least another said end-fire antenna.

2. A multi-beam antenna as recited in claim 1, wherein said dielectric substrate comprises a dielectric of a printed circuit.

3. A multi-beam antenna as recited in claim 1, wherein said at least one dielectric substrate is substantially planar.

4. A multi-beam antenna as recited in claim 1, wherein said at least one dielectric substrate comprises a conical surface.

5. A multi-beam antenna as recited in claim 1, wherein said plurality of antenna elements are located along at least a portion of said edge of said dielectric substrate, and said at least a portion of said edge of said dielectric substrate is curved.

6. A multi-beam antenna as recited in claim 5, wherein said at least a portion of said edge of said dielectric substrate is convex.

7. A multi-beam antenna as recited in claim 6, wherein said at least a portion of said edge of said dielectric substrate at least partially circular or elliptical.

8. A multi-beam antenna as recited in claim 7, wherein said at least a portion of said edge of said dielectric substrate comprises a continuous edge, said plurality of antenna elements are located along said continuous edge so as to provide for launching or receiving said electromagnetic waves in a corresponding plurality of directions, and said plurality of directions provide for launching or receiving at least a portion of said electromagnetic waves in substantially every direction substantially aligned with a surface of said dielectric substrate.

9. A multi-beam antenna as recited in claim 8, wherein said continuous edge is either at least partially circular or elliptical.

10. A multi-beam antenna as recited in claim 5, wherein said at least a portion of said edge of said dielectric substrate is concave.

11. A multi-beam antenna as recited in claim 10, wherein said at least a portion of said edge of said dielectric substrate at least partially circular or elliptical.

12. A multi-beam antenna as recited in claim 1, wherein each said antenna element comprises ar least one conductor operatively connected to said dielectric substrate.

13. A multi-beam antenna as recited in claim 1, wherein said end-fire antenna is selected from a slot antenna comprising either a tapered slot antenna, a Vivaldi antenna, a Fermi tapered slot antenna, a linearly tapered slot antenna, a broken linearly tapered slot antenna, or a dual exponentially tapered slot antenna.

14. A multi-beam antenna as recited in claim 1, wherein said end-fire antenna is either a Yagi-Uda antenna, a dipole antenna, a helical antenna, a monopole antenna, or a tapered dielectric rod.

15. A multi-beam antenna as recited in claim 1, wherein said end-fire antenna comprises a Yagi-Uda antenna, said Yagi-Uda antenna comprises a dipole element and a plurality of directors on a first side of said dielectric substrate, and at least one reflector on a second side of said dielectric substrate.

16. A multi-beam antenna as recited in claim 1, wherein said end-fire antenna comprises a monopole antenna adapted to extend away from a surface of said dielectric substrate.

17. A multi-beam antenna as recited in claim 1, further comprising at least one transmission line on said dielectric substrate, wherein at least one said at least one transmission line is operatively connected to a feed port of one of said plurality of antenna elements.

18. A multi-beam antenna as recited in claim 1, further comprising a switching network having an input and a plurality of outputs, said input is operatively connected to a corporate antenna feed port, and each output of said plurality of outputs is connected to a different antenna element of said plurality of antenna elements.

19. A multi-beam antenna as recited in claim 17, further comprising a switching network having an input and a plurality of outputs, said input is operatively connected to a corporate antenna feed port, and each output of said plurality of outputs is connected to a different antenna element of said plurality of antenna elements via said at least one transmission line.

20. A multi-beam antenna as recited in claim 18, wherein said switching network is operatively connected to said dielectric substrate.

21. A multi-beam antenna as recited in claim 17, wherein said transmission line is selected from a stripline, a microstrip line, an inverted microstrip line, a slotline, an image line, an insulated image line, a tapped image line, a coplanar stripline, and a coplanar waveguide line.

22. A multi-beam antenna as recited in claim 1, wherein said slot antenna is on a first side of said dielectric substrate and is terminated with a terminus of a slotline operatively coupled to or a part of said slot antenna on said first side of said dielectric substrate, further comprising a transmission line on a second side of said dielectric substrate, wherein said first and second sides oppose one another, and said transmission line adapted to provide for electromagnetic coupling to said slotline operatively coupled to or a part of said slot antenna.

23. A multi-beam antenna as recited in claim 22, wherein said terminus comprises a disc aperture.

24. A multi-beam antenna as recited in claim 22, wherein said transmission line comprises a microstrip line terminated with substantially quarter wave stub.

25. A multi-beam antenna as recited in claim 22, wherein at least a portion of said transmission line overlaps at least a portion of said slotline at a location of overlap, and said at least a portion of said transmission line is substantially orthogonal to said at least a portion of said slotline at said location of overlap.

26. A multi-beam antenna as recited in claim 1, further comprising at least one reflector on at least one side of dielectric substrate, wherein said at least one reflector is operatively associated with at least one said antenna element.

27. A multi-beam antenna as recited in claim 26, wherein said at least one reflector is adapted to conform to an edge of said dielectric substrate.

28. A multi-beam antenna as recited in claim 27, wherein said edge of said dielectric substrate is convex, and said at least one reflector comprises a convex bi-conical reflector.

29. A multi-beam antenna as recited in claim 27, wherein said edge of said dielectric substrate is concave, and said at least one reflector comprises a concave bi-conical reflector.

30. A multi-beam antenna as recited in claim 1, further comprising at least one cylindrical dielectric lens operatively associated with said plurality of antenna elements.

31. A multi-beam antenna as recited in claim 1, further comprising at least one planar lens operatively associated with said plurality of antenna elements.

32. A multi-beam antenna as recited in claim 17, further comprising: a filter circuit formed from a conductive layer on said dielectric circuit; and a detector operatively coupled to said filter circuit, wherein said filter circuit is operatively associated with said at least one transmission line, and said filter circuit is adapted to remove a carrier from a received signal.
